(19) United States
(12) Patent Application Publication
(10) Pub. No.: US 2004/0028382 A1
(43) Pub. Date: Feb. 12, 2004

(54) Video recording/reproducing apparatus and program list displaying method thereof

(76) Inventors: Hye-Jin Choi, Suwon-city (KR); Yun-Ju Kang, Suwon-city (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/633,634

(22) Filed: Aug. 5, 2003

(30) Foreign Application Priority Data
Aug. 8, 2002 (KR) 2002-46945

(51) Int. Cl. H04N 5/783

(52) U.S. Cl. 386/68; 386/81; 386/82

(57) ABSTRACT

A video recording/reproducing apparatus and a method of using the apparatus to display a program list display. The video recording/reproducing apparatus comprises an interface unit installed in a main body, for receiving a user's input signal from an external input device enabling selections of functions supported by the video recording/reproducing apparatus, and a main control unit for displaying guidance information for programs stored in the storage device on receipt of a program list display requesting signal of the video signal stored in the storage device from the external input device, the guidance information including information on a still image extracted from a predetermined part of entire videos of the program. The displayed program guidance information includes still image information of the stored programs, so that the user can perceive the contents of the programs without executing the respective programs.

PRIORITY

This application claims benefit under 35 U.S.C. § 119 from Korean Patent Application No. 2002-46945, filed on Aug. 8, 2002, the entire content of which is incorporated herein by reference.

### BACKGROUND OF THE INVENTION

1. Field of the Invention

The present invention relates to a video recording/reproducing apparatus and a program list displaying method thereof. More particularly, the present invention relates to a video recording/reproducing apparatus and a program list displaying method thereof, which provides a program list allowing a user to easily recognize and select information on programs stored in a storage device.

2. Description of the Prior Art

Video recording and reproducing apparatuses, capable of recording and reproducing broadcast signals on and from a recording medium, have expanded their functions in diverse ways with the digitizing of broadcast signals and the developing of compression technologies.

Currently available video recording/reproducing apparatuses appearing in the market employ a hard disk drive as a mass storage device. These video recording/reproducing apparatuses have been developed to support the use of diverse video sources, such as satellite broadcasts, cable broadcasts, network broadcasts through the internet, and so on.

However, the increase of available video sources and the expansion of functions using the sources exposes a deficiency in that the video recording/reproducing apparatuses have become more complicated to use, as users tend to use diverse functions such as channel selections, uses of programs stored in storage devices, and so on.

A conventional video recording/reproducing apparatus displays information on programs stored in the storage device, such as program title, storage time, a storage capacity, and so on, in order for a user to manage the programs. However, if there are a great number of stored programs, the user has difficulty in recognizing the contents of the programs using such above-described information. Also, when the user forgets a title of a stored program, he/she has to reproduce the listed-up programs one-by-one, to identify the contents thereof, which is inconvenient.

### SUMMARY OF THE INVENTION

An object of the invention is to substantially solve at least the problems and/or disadvantages mentioned above and to provide at least the advantages described below.

Accordingly, it is an object of the invention to provide a video recording/reproducing apparatus and an improved program list display method therefore. The video recording/reproducing apparatus comprises an interface unit installed in a main body, for receiving a user's input signal from an external input device enabling selections of functions supported by the video recording/reproducing apparatus, and a main control unit for displaying guidance information for programs stored in the storage device on receipt of a program list display requesting signal of the video signal stored in the storage device from the external input device. The guidance information includes information on an still image extracted from a predetermined part of entire videos of the program. The displayed program guidance information includes still image information of the stored programs, so that the user can perceive the contents of the programs without executing the respective programs.

### BRIEF DESCRIPTION OF THE DRAWINGS

The above aspect and other features of the present invention will become more apparent by describing a preferred embodiment thereof in detail, with reference to the attached drawings, in which:

FIG. 1 is a view showing a display system employing a video recording/reproducing apparatus according to an embodiment of the present invention;

FIG. 2 is a block diagram showing the video recording/reproducing apparatus of FIG. 1;

FIG. 3 is a plan view showing an example of the remote controller of FIG. 1;

FIG. 4 is a view showing an example of an initial menu guide list screen displayed in a display device when a menu key in FIG. 3 is selected;

FIG. 5 is a view showing an example of a screen subsequently displayed when a digital recorder is selected from the menu guide list of FIG. 4;

FIG. 6 is a view showing an example of a screen displaying guide information about programs stored in a storage device when the program list menu of FIG. 5 is selected;

FIG. 7 is a view showing an example of a title change screen subsequently displayed when the title item of FIG. 6 is selected;

FIG. 8 is a block diagram showing an example of a structure of information about the program stored in the storage device of the video recording/reproducing apparatus of FIG. 2; and

FIG. 9 is a flowchart showing a program list displaying method of a video recording/reproducing apparatus according to an embodiment of the present invention.

### DETAILED DESCRIPTION OF THE PREFERRED EMBODIMENT

Hereinafter, a video recording/reproducing apparatus according to an embodiment of the present invention will be described in more detail with reference to the accompanying drawings.

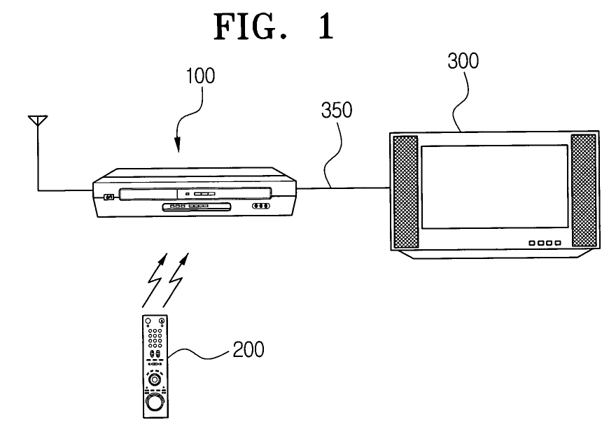

FIG. 1 is a view schematically showing a display system employing a video recording/reproducing apparatus according to an embodiment of the present invention.

Referring to FIG. 1, a video recording/reproducing apparatus 100 is connected to a television set 300 through a transmission cable 350.

The video recording/reproducing apparatus 100 processes a signal received from a remote controller 200, and transfers display information to the television 300. Remote controller 200 is one example of an external input device, and in this instance, remote controller 200 transmits a radio signal (which can also be an infrared signal). Another type of an external input device is a wire-type keyboard.

The video recording/reproducing apparatus 100 is constructed to receive at least one or more video signals provided from a plurality of video sources. For example, video sources may include ground wave television broadcasts, satellite broadcasts, cable service lines, and other media capable of transmitting signals, such as computer lines or modem lines. The embodiments of the present invention described hereinafter is applied to a video recording/reproducing apparatus which is built to receive at least one or more video sources such as cable, satellite dish antenna, local cable, digital broadcast source (DBS), general antenna, Internet, other computer source, camcorder, disc player, set-top box, and so on.

The video recording/reproducing apparatus 100 also includes a mass storage device for storing video signals and the like. One example of a mass storage device is a hard disk drive.

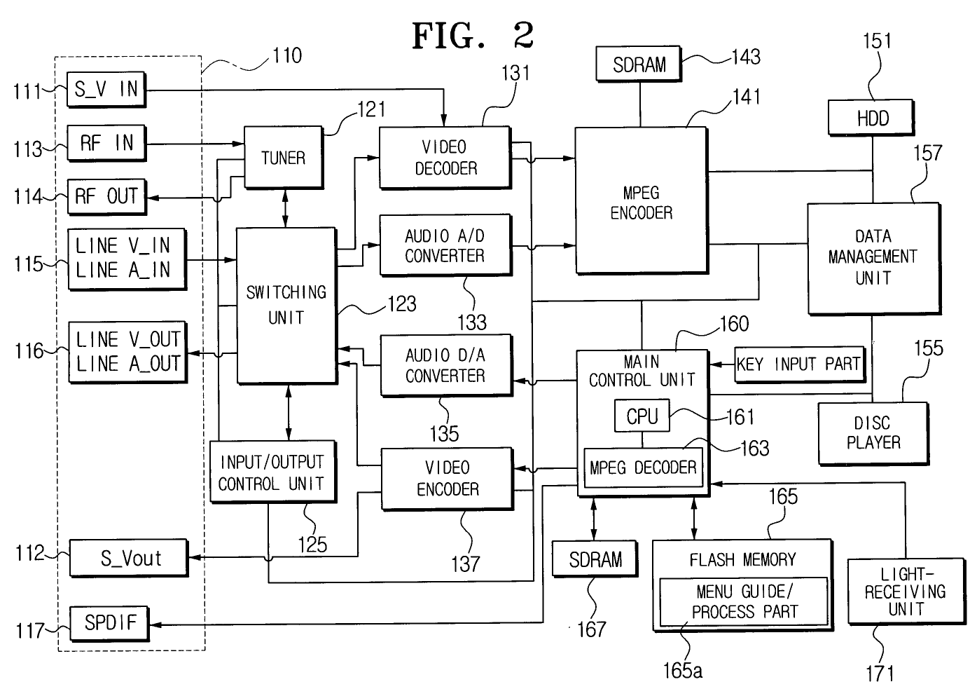

A block diagram for such a video recording/reproducing apparatus is shown in FIG. 2. Referring to FIG. 2, the video recording/reproducing apparatus 100 includes an input/output terminal unit 110, a tuner 121, a switching unit 123, an input/output control unit 125, an MPEG encoder 141, a hard disc drive (HDD) 151, a disc player 155, and a main control unit 160, as well as other components.

The input/output terminal unit 110 receives signals generated from diverse video sources, and outputs the received signals or signals reproduced from the hard disc drive 151, which is employed as a mass storage device.

The input/output terminal unit 110 is provided with a super video input terminal (S_V IN) 111, a super video output terminal (S_V OUT) 112, a RF input terminal (RF IN) 113, a RF output terminal (RF OUT) 114, a line video/audio input terminal (LINE V_IN, LINE A_IN) 115, a line video/audio output terminal (LINE V_OUT, LINE A_OUT) 116, and a digital audio signal output terminal (or Serial Parallel Digital interface; SPDIF) 117.

The input terminals and output terminals will now be described in greater detail with respect to a constituent different in input/output relations but identical in signal format. The super video input terminal 111 is a terminal receiving a luminance signal Y and chrominance signals Cr and Cb. these signals are separated in digital format from one another. These signals can be received from a digital camcorder, a DVD player, a set-top box, and so on.

The RF input terminal 113 is a terminal receiving pubic broadcast signals, which is generally connected to an antenna.

The line video/audio input terminal 115 is a terminal receiving an analog signal composite with the luminance signal Y and the chrominance signals. The line video/audio input terminal 115 is connected to a camcorder, a DVD player, a set-top box, or the like, for use that supports an output of an analog video signal.

The digital audio output terminal 117 is a terminal for externally outputting a digital audio signal transmitted from the main control unit 160.

The tuner 121 adjusts a receiving channel in order for a broadcast signal to be received through the RF input terminal 113. The channel is requested from the input/output control unit 125 controlled by the main control unit 160.

The switching unit 123 is controlled by the input/output control unit 125 to selectively and mutually connect the input/output terminals connected to the switching unit 123.

A video decoder 131 is controlled by the main control unit 160 to decode and output a signal received through the super video input terminal 111 or the switching unit 123.

An audio A/D converter 133 digitizes and outputs to the MPEG encoder 141 an analog audio signal which is selected via the switching unit 123.

The MPEG encoder 141 is controlled by the main control unit 160. The MPEG encoder 141 encodes the audio signal output from the audio A/D converter 133 and a video signal output from the video decoder 131 according to a pre-determined compression format, and stores data, which is to be recorded, in the hard disc drive 151. Preferably, the MPEG encoder 141 performs the encoding based on the MPEG-2 compression format.

Reference numeral 143 indicates an SDRAM employed as a memory to be used upon the encoding process in the MPEG encoder 141.

A data management unit 157 manages the reproduction and records of data recorded in the hard disc drive 151 and/or the disc player 155. The data management unit 157 is controlled by the main control unit 160 to manage storing the data recorded on a disc located in disc player 155, into the hard disc drive 151, or storing the data recorded in the hard disc drive 151 into the disc player 155 (and then onto a disc), and storing the data encoded in the MPEG encoder 141 into the hard disc drive 151.

The disc player 155 is built in the video recording/reproducing apparatus. The disc player 155 may be a digital video disk (DVD) player reproducing the data recorded in a recording medium such as a DVD and/or a compact disk (CD).

The disc player 155 is controlled by the main control unit 160, and is connected to perform recording/reproducing operations.

The light-receiving unit 171, as an interface, receives and outputs to the main control unit 160 a user manipulation signal transmitted from the remote controller 200.

The main control unit 160 processes the user manipulation signal received through the light-receiving unit 171 and controls respective constituent components.

The main control unit 160 is formed in a single IC chip form in which the central processing unit (CPU) 161 and the MPEG decoder 163 for decoding signals compressed in the MPEG format are combined. The MPEG decoder 163 can be a separate chip to be connected to the main control unit 160.

In the flash memory 165 are stored various programs related to performing the functions of the main control unit 160 and manipulating data. A menu guide/process part program 165a is installed in the flash memory 165; the menu guide/process part 165a is a program for processing a menu guide list display. The menu guide list display includes a program list, which will be described in detail below. Reference number 167 indicates an SDRAM used as a temporal storage area by the main control unit 161.

The audio D/A converter 135 converts a digital audio signal output from the MPEG decoder 163 into an analog audio signal, and outputs it to the switching unit 123 of the main control unit 160.

The video encoder 137 encodes and outputs to the switching unit 123 a video signal output from the video decoder 131 or the MPEG decoder 163.

The input/output controller 125 is controlled by the main control unit 160 to control the tuner 121 and the switching unit 123.

The main control unit 160 in such a video recording/reproducing apparatus loads an operation program built in the flash memory 165 upon starting (power-up), and processes many different types of supported functions based on a signal received from the remote controller 200 through the light-receiving unit 171.

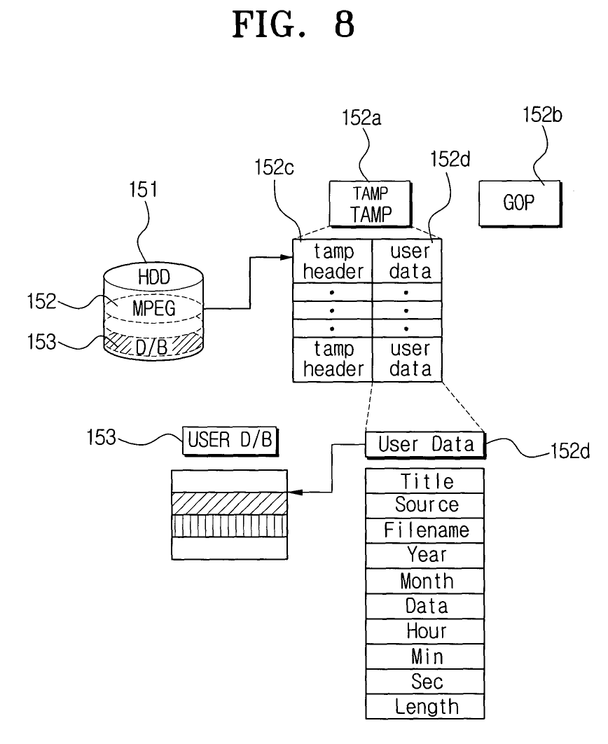

A structure of the data recorded in the hard disc drive 151 of such a video recording/reproducing apparatus is shown in FIG. 8.

Referring to FIG. 8, data encoded by the MPEG encoder 141 according to a user's command is recorded on the hard disc drive 151 of a mass storage device of the video recording/reproducing apparatus 100. Preferably, the data is encoded to MPEG file 152 in the MPEG-2 compression format.

The MPEG file 152 is comprised of a time-map (TMAP) part 152a and video data, i.e., group of pictures (GOP) 152b. The time-map part 152a is a table for linking an arrival time stamp (ATS) message of a stored source packet to a location of a disc packet. The ATS is comprised of a header 152c, having GOP recording location information and user data 152d, such as information index for program title, location information of the source, time, length, file name, and the like.

Preferably, in order to manage the stored MPEG file 152, a user D/B 153 on the stored file is constructed in the hard disc drive 151, based on the information of the header 152c and the user data 152d of the MEPG file 152. In order to display still image information included in a program list display, the user D/B 153 includes location information of the still image. Also, the user D/B 153 includes program title information, file names, file reproducing time, and year, month, day, time, minute, and second on which the program was recorded.

A menu guide/process part 165a uses the user D/B 153 in order to construct the program list of the stored MEPG file 152.

A program list display, for storing and managing the program using the remote controller, will now be described.

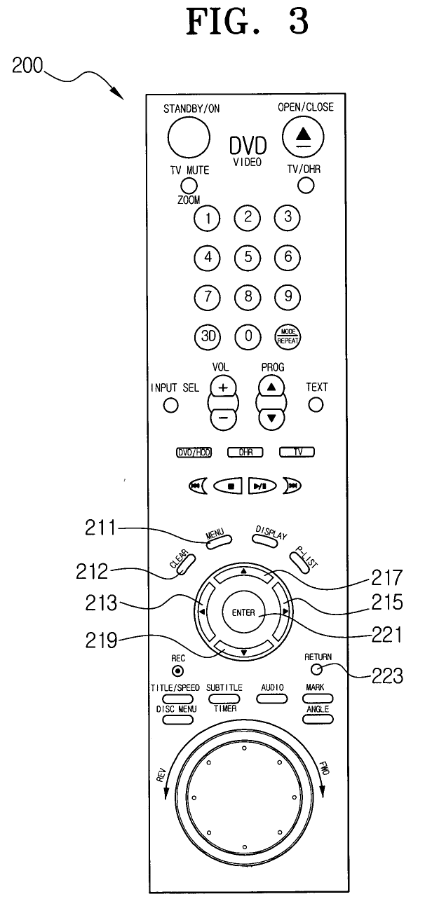

The elements related to manipulating the menu guide display are generally described with reference to FIG. 3 showing the remote controller 200 used with the video recording/reproducing apparatus according to an embodiment of the present invention.

Reference number 211 in FIG. 3 indicates a menu key used to instruct the loading and closing of a menu guide list display. The parts numbered 213, 215, 217, and 219 are left, right, up, and down keys which are assigned to the menu guide list displays described below, and are used to instruct the movements of a cursor with respect to the listed menus. Also, reference number 212 is an enter key used to select a menu, and reference number 223 refers to a return key used to return a current display to a previous display.

The rest of the keys are well known to those skilled in the art. A detailed description of the keys used to manipulate the video recording/reproducing apparatus 100, television 300, and so on, will be omitted, since the functions of these keys can be easily understood through letters marked next to the keys, and the embodiments of the present invention can be understood by those skilled in the art, even though the detailed description on the functions of the respective keys is omitted.

In order to display a program list to provide information of programs recorded in the hard disc drive 151, a menu guide list is displayed on the television 300 and the remote controller 200 is used to control the menu guide list.

An example of operations for displaying the menu guide list on the television 300 and controlling functions of the video recording/reproducing apparatus 100 using the menu guide list, in relation to the program list display, will now be described.

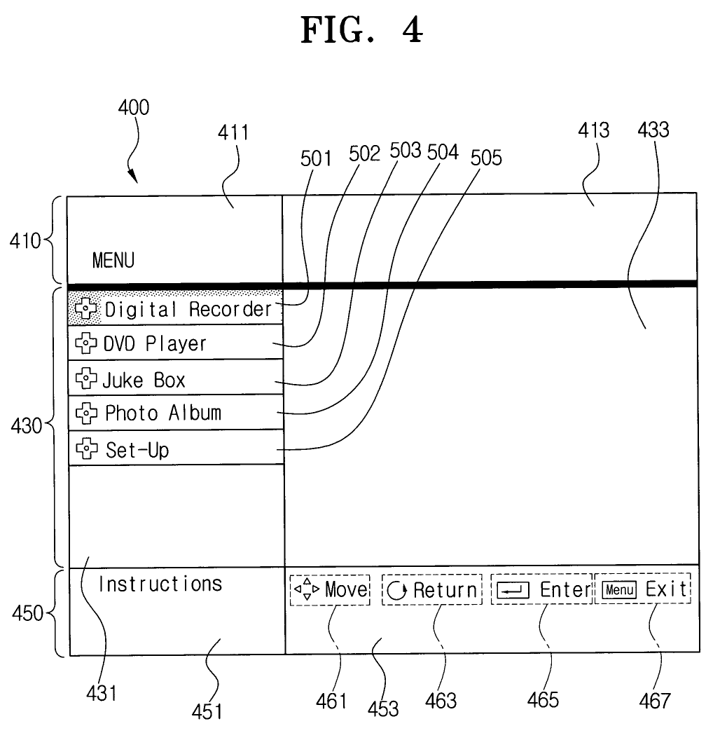

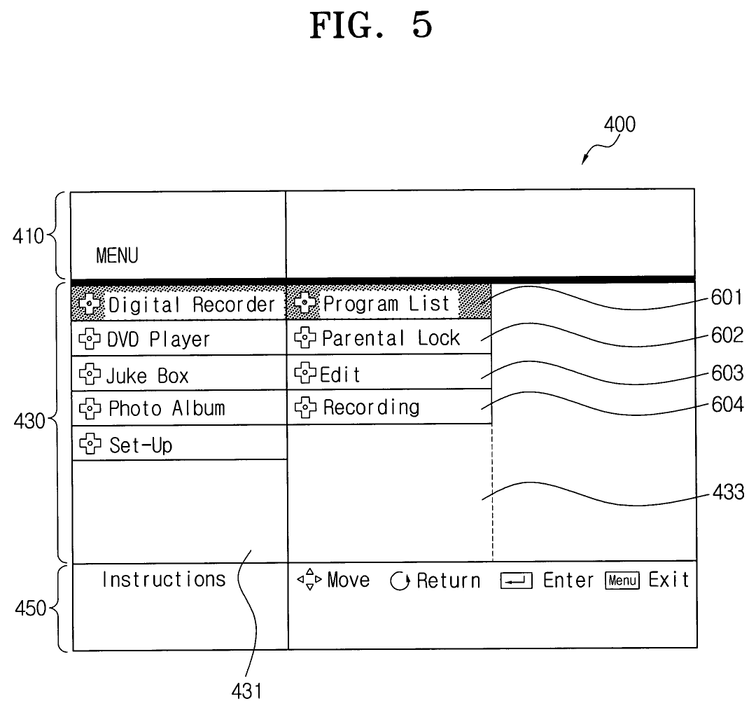

Referring to FIG. 4, an example of a menu guide list initial display is illustrated. On the menu guide list initial display 400, main menus are displayed. When any one is selected from the main menus, as shown in FIG. 5, sub-menus belonging to the selected main menu are displayed in a region corresponding to a second block 433 out of the regions located on the right side of a first block 431 on which the main menus are located.

The main menus comprise a “Digital Recorder” menu 501 for managing the data stored in the hard disc drive 151 and a “DVD Player” menu 502 for controlling programs stored in the DVD player 155. In addition to these, the main menus also include a “Juke Box” menu 503, a “Photo Album” menu 504, and a “Set Up” menu 505.

For example, when the “Digital Recorder” menu 501 is selected from the main menus, as shown in FIG. 5, the sub menus belonging to the selected “Digital Recorder” menu 501 are vertically displayed in a column together with the main menu in the second block 433. As also shown in FIG. 4, the menu guide list display is vertically divided into an upper region 410, a middle region 430, and a lower region 405, and horizontally divided into first blocks 411, 431, 451 in the left side and second blocks 413, 433, and 453 in the right side.

When the menu key 211 of the remote controller 200 is selected, the main control unit 160 provides the menu guide list display 400, with the main menus being displayed on the first block 431 located in the left side of the screen. After that, when any one of the menus are selected from the main menus, the main control unit 160 provides a menu display in accordance with a menu display method, so that the sub menus belonging to the selected main menu are displayed in the second block 433, allocated in the right side of the first block 431.

Manipulation information on the keys of the remote controller 200 is displayed in the lower region 450 of the screen corresponding to the use of the menu guide list display 400. As shown in the drawings, the word “Instructions”, which is for guiding the key manipulation, is displayed in the first block 451 of the lower region 450, divided side by side, and vertically from the first block 411 of the upper region 410 and the first block 431 of the middle region 430. In the second block 453, guidance information on the keys provided on the remote controller 200 and their functions is displayed on the right side of the first block 451.

Marks and guidance information displayed on the lower region 450, as shown in FIG. 5, are generally referred to as ‘marks’. In the lower region 450 a cursor movement guidance mark 461, a return guidance mark 463, a selection guidance mark 465, and an exit guidance mark 467 (these are named to match the functions) are displayed.

The cursor movement guidance mark 461 is used to move a cursor for selectable items arranged in the middle region 430, and is displayed with direction key marks corresponding to direction keys 213, 215, 217, and 219 provided on the remote controller 200, and “Move” which is manipulation information on the keys. Here, the cursor movement guidance mark 461 refers generally to any mark that a user can recognize a movement from an item on which a cursor is currently located, to a next item arranged in a position corresponding to the manipulation direction of the direction keys 213, 215, 217, and 219 when they are manipulated. This manipulation can be implemented in several different methods. These methods include, but are not limited to, providing an extra mark, highlighting a display, shading the display, color-changing the display, and so on, for each corresponding item.

The return guidance mark 463 is used when a user changes displays from a current display to a previous display. The return guidance mark 463 corresponds to the return key 223 provided on the remote controller 200. Manipulation information “Return” is displayed as the return guidance mark 463.

The selection guidance mark 465 is used when an item over which the cursor hovers is selected. The selection guidance mark 465 corresponds to the Enter key 221 provided on the remote controller 200, and thus “Enter” is displayed as the selection guidance mark 465. The exit guidance mark 467 is used when a user changes the display mode of menu guide list display 400 to another mode. The exit guidance mark 467 would be used, for example, when a user closes the menu guide list display The exit guidance mark 467 corresponds to the menu key 211 supplied on the remote controller 200, and thus “Exit” is displayed as the exit guidance mark 467. Accordingly, a user can manipulate the up, down, left, and right direction keys 213, 215, 217, and 219 provided on the remote controller 200 when he or she desires to move the cursor around on items listed in the middle region 430.

Further, if a user manipulates the Enter key 221 provided on the remote controller 200 when selecting a menu over which the cursor hovers, the main control unit 160 displays a subsequent screen corresponding to the selection of the menu on which the cursor is placed on the display device. In the event there exists sub-menus belonging to the menu over which the cursor hovers, the sub-menus are displayed in the menu display, in accordance with the manner described above. In the situation in which there are no existing sub-menus, an execution screen for a selected menu is displayed in the middle region 430.

In the case that there are no sub-menus belonging to a menu over which the cursor hovers when the right direction key 215 is selected out of the direction keys 213, 215, 217, and 219 provided on the remote controller 200 for the cursor-hovering menu, the process of the main control unit 160 is the same as that for the manipulation of the Enter key 221 so that an execution screen corresponding to the menu is displayed in the middle region 430.

If a selection signal of the menu key 211 is put in a state such that the menu guide list display 400 is loaded into the television set 300, the menu guide list display 400 is processed unloaded. As a result, the menu guide list display 400 is not shown on the display device, and the menu guide list display is closed.

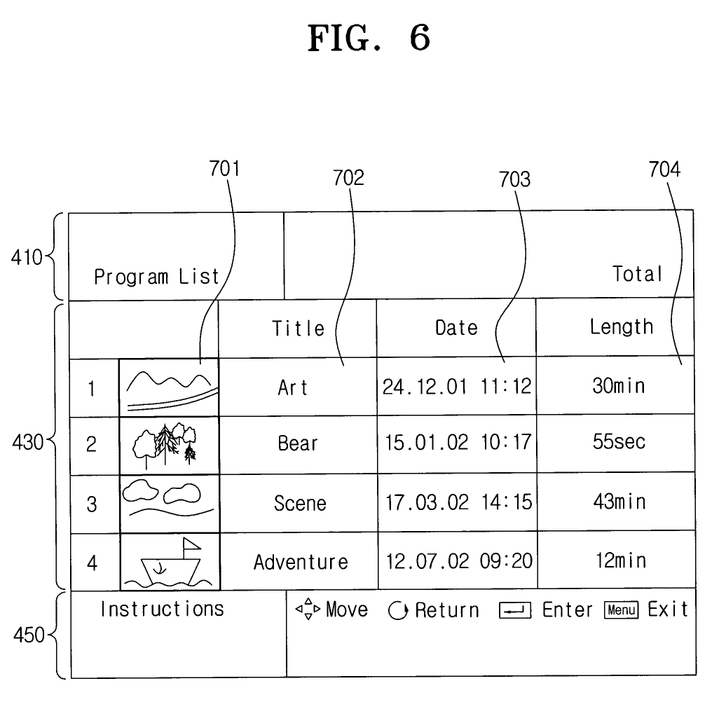

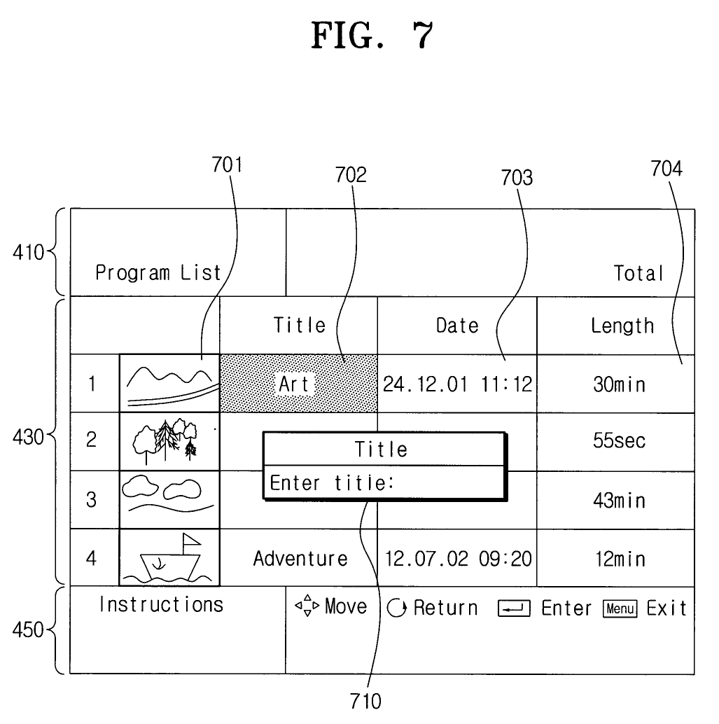

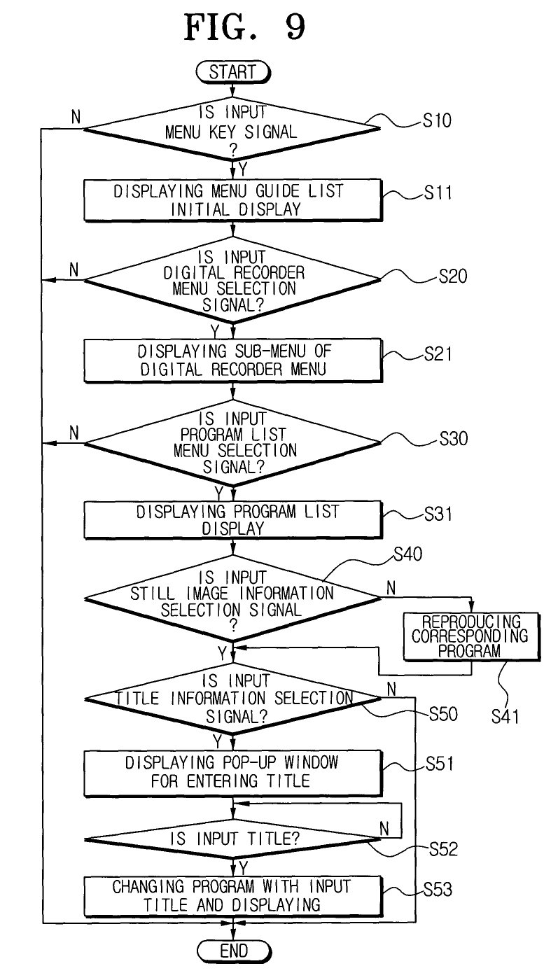

A program list displaying method according to an embodiment of the present invention will now be described in greater detail with reference to FIGS. 5 through 9. FIG. 5 shows a screen for selecting a menu of a menu guide list, and FIGS. 6 and 7 show a program list. FIG. 9 is a flowchart showing a program list displaying method, and in the following description, the notation “Snn” refers to step “nn” of the flowchart.

In order to display a video signal program list recorded on the hard disc drive 151, the “Program List” menu 601 has to be selected in the menu guide list display.

For this selection, the menu key 211 of the remote controller 200 is selected and the menu guide list initial display 400 is displayed on the television 300, as shown in FIG. 4 (steps S10 and S11). The display illustrated in FIG. 5 occurs after a user manipulates the cursor to the “Digital Recorder” menu 501 by using the direction keys 217 and 219 of the remote controller 200. The “Enter key” 221 is then manipulated (or pressed), and the “Digital Recorder” menu 501 is selected. The sub-menus of the “Digital Recorder” menu 501, including the “Program List” menu 601, are subsequently displayed, as shown in FIG. 5 (steps S20 and S21). At this point, when the cursor is moved to the “Program List” menu 601 by manipulating the direction key 215, and the “Enter key” 221 is manipulated, the “Program List” menu 601 is selected (step S30).

The main control unit 160 subsequently changes the current display, by listing the guidance information on the programs recorded on the hard disc drive 151 in the middle region 430, and displays the guidance information (step S31). The program guidance information includes, among other types of information (described below), still image information 701, which displays a still image. The still image is extracted from a predetermined section of a video source of a program as it is recorded. The guidance information also comprises, title information 702, recording date information 703, and reproducing time information 704 (which corresponds to the total length of the program). The program guidance information is constructed by using contents of the user D/B of the hard disc drive 151.

In one embodiment of the invention, it is preferable that the still image information 701 be extracted from a first scene of the stored program. The still image information 701 enables the user to recognize the contents of the stored program. This may be especially useful in the case of storing intermediate signals among streamed broadcasting signals, wherein the first scene of a corresponding program enables the user to recognize the location of the program among the entire A/V data of the stored programs. Additionally, the still image information 701 is displayed in a scaled-down screen. It is preferable that the scaled-down screen corresponds to ⅛of the main screen, though that need not always be the case.

The stored program can be managed through manipulation of the enter key 221 when the cursor is located on an item of the program guidance information displayed on the screen. If the cursor is located in any one image of the still image information 701, among the displayed program guidance information, and the enter key 221 is manipulated, the main control unit 160 reproduces the corresponding program (steps S40 and S41).

If the cursor is located in the title information 702 and the enter key 221 is manipulated, a pop-up window for entering a title is displayed, as shown in FIG. 7, thereby allowing the user to change the title (steps S50 and S51). If the user inputs a new title, the program list is changed with the input title and the changed program list display is re-loaded on the television 300 (steps S52 and S53).

As described above, the program list according to the present invention includes the still image information of the stored programs, which are displayed together with the other program guidance information, so that the user can perceive the contents of the stored programs without executing the respective programs. Also, the user can recognize the stored programs more easily by directly changing the title on the program list display.

According to the embodiments of the present invention described above, when the video recording/reproducing apparatus displays the guidance information list on the stored program stored, it displays the information with predetermined still image information of the stored program, thereby allowing a user to easily recognize the contents of the stored program.

Furthermore, the video recording/reproducing apparatus of the present invention allows the user to easily change the title of the program in the program list. Accordingly, the user can remember the title more easily in the future

Although the preferred embodiment of the present invention has been described, it will be understood by those skilled in the art that the present invention should not be limited to the described preferred embodiment, but various changes and modifications can be made within the spirit and scope of the present invention as defined by the appended claims.

What is claimed is:

1. A method for displaying guidance information for programs stored in a video recording/reproducing apparatus, comprising:
receiving a user's input signal;
enabling selections of functions supported by the video recording/reproducing apparatus based on the received user's input signal; and
displaying guidance information for programs stored in the storage device on a display where said received user's input signal includes a program list display request signal.

2. The method according to claim 1, wherein the step of receiving a user's input signal comprises:
receiving the user's input signal from an external input device

3. The method according to claim 1, wherein the program list display request signal corresponds to a video signal stored in a storage device associated with the video recording/reproducing apparatus.

4. The method according to claim 1, wherein the guidance program information includes information on a plurality of still images extracted from a predetermined part of a plurality of video signals stored in a storage device associated with the video recording/reproducing apparatus.

5. A video recording/reproducing apparatus comprising:
an interface unit for receiving a user's input signal to enable selections of functions supported by the video recording/reproducing apparatus; and
a main control unit for controlling a display to display guidance information for at least one of the programs stored in the storage device when said received user's signal includes a program list display request signal for a video signal stored in the storage device.

6. The video recording/reproducing apparatus according to claim 5, further comprising:
a storage device adapted to store a plurality of programs.

7. The video recording/reproducing apparatus according to claim 6, wherein the plurality of programs stored in the storage device comprise video signals.

8. The video recording/reproducing apparatus according to claim 5, wherein the interface unit is installed in a main body of the video recording/reproducing apparatus.

9. The video recording/reproducing apparatus according to claim 5, wherein the user's input signal is received from an external input device.

10. The video recording/reproducing apparatus according to claim 5, wherein the external input device is a remote control.

11. A method for displaying guidance information for programs stored in a video recording/reproducing apparatus, comprising:
displaying a main menu list, comprising at least one main menu, after receiving a menu key request signal;
selecting a main menu from the main menu list;
displaying at least one sub menu corresponding to the selected main menu;
selecting a sub menu from the at least one or more displayed sub menus; and
displaying guidance information regarding programs stored in the video recording/reproducing apparatus relating to the selected sub menu.

12. The method according to claim 11 wherein the main menu list comprises a plurality of major functions pertaining to the video recording/reproducing apparatus.

13. The method according to claim 12 wherein the major functions pertaining to the video recording/reproducing apparatus comprises a digital recorder, DVD player juke box, photo album and set-up.

14. The method according to claim 11 wherein the step of receiving a menu key request signal comprises receiving an input signal from an external input device.

15. The method according to claim 14 wherein the user's input signal comprises a digital recorder request signal.

16. The method according to claim 11 wherein the step of selecting comprises manipulating a series of keys on an external input device

17. The method according to claim 16 wherein the external input device is a remote control.

18. The method according to claim 17 wherein the remote control comprises user manipulative buttons.

19. The method according to claim 11 wherein the main menu list is a display on the left side of the middle region of the display.

20. The method according to claim 11 wherein the submenu list is displayed adjacent to the main menu list in the middle region of the display.
